(19) United States
(12) Patent Application Publication
(10) Pub. No.: US 2016/0348710 A1
(43) Pub. Date: Dec. 1, 2016

(54) FASTENING ELEMENT

(71) Applicant: NEDSCHROEF FRAULAUTERN GMBH, Saarlouis (DE)

(72) Inventor: Dirk HEIN, Hohen Neuendorf (DE)

(73) Assignee: Nedschroef Fraulautern GmbH, Saarlouis (DE)

(21) Appl. No.: 15/103,485

(22) PCT Filed: Jun. 25, 2014
(86) PCT No.: PCT/EP2014/063326

§ 371 Date: Jun. 10, 2016

(30) Foreign Application Priority Data
Jun. 26, 2013 (EP) 13173853.6

(51) Int. Cl. F16B 35/04

(52) U.S. Cl. CPC F16B 35/047

(57) ABSTRACT

A fastening element includes a cylindrical threaded portion having an external thread which transitions into a transition thread of an adjoining centering portion, the transition thread having at least one turn. The at least one transition thread turn is designed in such a way that its flanks transition into a curved surface, the centering portion having a threading portion including a frusto-conical portion at the end.

The invention relates to a fastening element, for example a screw or a bolt, comprising a cylindrical thread segment having an outside thread that makes a transition into a transition thread, having at least one transition thread turn, of a subsequent centering segment, wherein the at least one transition thread turn is configured in such a manner that its flanks make a transition into a curved surface.

Fastening elements of the aforementioned type are described, for example, in DE 696 10 838 T2. These fastening elements are formed by a cylindrical element, such as, for example, a bolt or a screw having an outside thread that runs in helical form on the shaft. The outside thread makes a transition into a transition thread turn, which has a curved transition surface from the smaller diameter to the larger diameter. The curved transition surface is designed for coming into engagement, by way of the complementary part thread turns of a second element having an inside thread, such as a nut, for example, when it is in a thread damage position. The transition thread turn is followed by a cylindrical formation. This formation restricts the range of the setting angle when the fastening element is introduced into the second element having an inside thread. In this way, possible incorrect alignment can be restricted, so that at least one helical thread turn can come into engagement with the curved transition surface, by way of the thread turns of the complementary part, so that the fastening element is aligned in collinear manner.

Fastening elements of the aforementioned type have proven themselves in practice. In the case of automated screwing procedures, in particular, thread damage can be avoided to a great extent. It is the task of the present invention to further improve the fastening elements of the aforementioned type while maintaining the screw connection quality. According to the invention, this task is accomplished by means of the characteristics of the characterizing part of claim 1.

With the invention, a fastening element is created, which is improved as compared with the fastening element known in the state of the art, while maintaining the screw connection quality. Surprisingly, it was found that the collinear alignment of the fastening element is improved by means of the provision of an end-side truncated cone segment. The cylindrical formation provided in the state of the art can be eliminated, in this regard, and thereby the fastening element turns out to be simultaneously shorter and therefore also lighter.

In a further development of the invention, the threading-in segment has a second truncated cone segment having a greater opening angle, placed ahead of the truncated cone segment. In this way, a further improvement of the collinear alignment is achieved.

Preferably, the truncated cone segment has an opening angle of 80 to 100 degrees, preferably 90 degrees. It was found that an optimal collinear alignment is achieved at this opening angle. In this regard, it is advantageous if the second truncated cone segment has an opening angle of 40 to 50 degrees, preferably 45 degrees.

In a further embodiment of the invention, the ratio of the diameter of cover surface and base surface of the truncated cone segment on the end side amounts to essentially one to three. In this way, maximal shortening of the fastening element with unreduced collinear alignment is achieved.

In a further development of the invention, the core diameter of the at least one transition thread turn of the transition thread is equal to the core diameter of the outside thread of the thread segment. In this way, gentle sliding of the fastening element into the complementary element having the inside thread is achieved. In this regard, the outside diameter of the transition thread is preferably smaller than the outside diameter of the outside thread of the thread segment. Good alignment properties can be achieved if the curved surface of the at least one transition thread turn has an arc-shaped cross-section.

Other further developments and embodiments of the invention are indicated in the remaining dependent claims. An exemplary embodiment of the invention is shown in the drawing and will be described in detail below. The figures show:

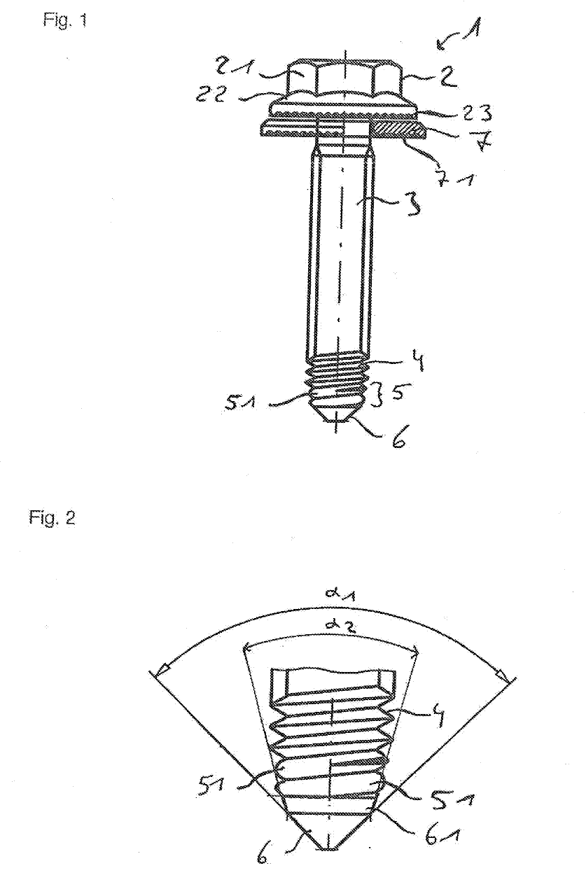

FIG. 1 the schematic representation of a self-centering screw, and

FIG. 2 a detail view of the screw from FIG. 1.

The fastening element selected as the exemplary embodiment is configured as a screw 1, having a head 2 onto which a shaft 3 is formed. The shaft 3 is provided with a thread segment having an outside thread 4, which makes a transition into a transition thread 5, which is followed by a truncated cone segment 6 formed onto the shaft 3, which segment forms a centering segment. A disk 7 is disposed on the shaft 3 below the head 2.

The head 2 of the screw 1, which is configured as an M10 screw in the exemplary embodiment, is provided, in known manner, with a six-band profile 21, which makes a transition into a flange part 22. The flange part 21 is provided with a tooth system 23 on its side facing the disk 7. Likewise, the disk is also provided with a tooth system 71 on its side facing away from the flange part 22.

The thread 4 introduced into the shaft 3 is structured as a metric thread in the exemplary embodiment and makes a transition, on the end side, into a transition thread 5 that has two transition thread turns 51 in the exemplary embodiment. The transition thread 5 has the same outside diameter as the thread 4 and is configured in such a manner that its flanks make a transition into a curved surface that have an arc-shaped cross-section.

A truncated cone segment 6 that is formed onto the shaft 3 follows the transition thread 5. In this regard, a second truncated cone segment 61 is disposed between the truncated cone segment 6 and the shaft 3, which segment has a smaller opening angle than the truncated cone segment 6. In the exemplary embodiment, the truncated cone segment has an opening angle of α₁=90 degrees, and the second truncated cone segment has an opening angle of α₂=45 degrees. The cover surface of the conical segment 6 has a diameter of 2.5 mm in the exemplary embodiment; the diameter of the cover surface of the truncated cone segment 6, which simultaneously represents the base surface of the second conical segment, amounts to 7.64 mm. This results in a ratio of the diameters of cover surface and base surface of essentially 1:3. The cover surface of the second conical segment 61 has a diameter of 8.23 mm.

1. Fastening element, comprising a cylindrical thread segment having an outside thread that makes a transition into a transition thread, having at least one transition thread turn, of a subsequent centering segment, wherein the at least one transition thread turn is configured in such a manner that its flanks make a transition into a curved surface, wherein the centering segment has a threading-in segment having a truncated cone segment (6) on the end side.

2. Fastening element according to claim 1, wherein the threading-in segment has a second truncated cone segment (61) having a greater opening angle, placed ahead of the truncated cone segment (6).

3. Fastening element according to claim 1, wherein the truncated cone segment (6) has an opening angle of 80 to 100 degrees, preferably 90 degrees.

4. Fastening element according to claim 2, wherein the second truncated cone segment (61) has an opening angle of 40 to 50 degrees, preferably 45 degrees.

5. Fastening element according to claim 1, wherein the transition thread (5) has two or more thread turns (51).

6. Fastening element according to claim 1, wherein the ratio of the diameter of cover surface and base surface of the truncated cone segment (6) on the end side essentially amounts to one to three.

7. Fastening element according to claim 1, wherein the core diameter of the at least one transition thread turn (51) of the transition thread (5) is equal to the core diameter of the outside thread (4) of the thread segment.

8. Fastening element according to claim 1, wherein the outside diameter of the transition thread (5) is smaller than the outside diameter of the outside thread (4) of the thread segment.

9. Fastening element according to claim 1, wherein the curved surface of the at least one transition thread turn (51) has an arc-shaped cross-section.
